(19) United States
(12) Patent Application Publication
(10) Pub. No.: US 2005/0132055 A1
(43) Pub. Date: Jun. 16, 2005

(54) System and method to control appliances using adaptive interfaces

(76) Inventor: Raja Neogi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/734,554

(22) Filed: Dec. 12, 2003

(51) Int. Cl. G06F 15/16

(52) U.S. Cl. 709/227; 700/28; 348/14.05

(57) ABSTRACT

A system and method to control appliances using adaptive interfaces. A session is established between a remote control, an appliance and a media center. The user is then authenticated at the media center to determine a user interface and an execution environment for the appliance. The user interface and the execution environment is sent to the appliance. The user interface is sent to the remote control. The media center receives a command from the user via the remote control and the user interface to operate the appliance. The command may involve downloading modifications to the user interface or downloading a new application and a new user interface for the appliance.

### BACKGROUND

The importance for the consumer appliance industry to continuously strive to produce products that are easy to use cannot be overstated. No doubt this is one of the reasons for the introduction of the remote control. But, as the number of indoor appliances in a home that can be controlled remotely continues to grow, so does the frustration of trying to keep each appliance's remote control separate from other appliances' remote controls. For example, today's homes may have a separate remote control for its television, digital video disk (DVD) player, video cassette recorder (VCR) player, oven, thermostat, set-top box, stereo, jukebox, ceiling fan, etc. Trying to keep this many remote controls separate and easily locatable is not only a challenge but also reduces the ease of use of each of the appliances.

In addition, the remote controls in use today are unidirectional and rigid. The protocols used by these remote controls cannot be customized and the interfaces cannot be personalized. Media centers may need to incrementally add new applications (e.g., remote messaging, urgent announcements, etc.) that need extra buttons, or aggregate user interfaces pertaining to multiple appliances (e.g., television and set-top box). Some users may not like the layout of the buttons on the remote control. Novice or young users may initially care for the very simple and intuitive interfaces (e.g., go, stop, volume-control and channel change), instead of a complex list of all the buttons.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for controlling appliances using adaptive user interfaces, in which some embodiments of the present invention may operate;

FIG. 2 illustrates a four layer model of networked appliances according to an embodiment of the invention;

FIG. 3 illustrates one embodiment of a media center in which some embodiments of the present invention may operate;

FIG. 4 is a diagram that illustrates one embodiment of session establishment between a remote control, an appliance and a media center;

FIG. 5 is a flow diagram of one embodiment of a process for establishing a session between a remote control, an appliance and a media center;

FIG. 6 is a flow diagram of one embodiment of a process for allowing the user to modify a default user interface;

FIG. 7 a flow diagram of one embodiment of a process for saving the user's edits to his or her portable user interface (processing block 608 of FIG. 6);

FIG. 8 is a flow diagram of one embodiment of a process for downloading new versions of manufacturer appliance applications and default user interfaces;

FIG. 9 illustrates one embodiment of a software implementation for establishing a session between a remote control, an appliance and a media center; and

FIG. 10 is a flow diagram of one embodiment of a software implementation for establishing a session between a remote control, an appliance and a media center.

### DESCRIPTION OF EMBODIMENTS

A method and system for controlling appliances (or devices) using adaptive user interfaces (UIs) are described. In the following description, for purposes of explanation, numerous specific details are set forth. It will be apparent, however, to one skilled in the art that embodiments of the invention can be practiced without these specific details.

Embodiments of the present invention may be implemented in software, firmware, hardware, or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and hardware components.

Thus, a machine-readable medium may include any mechanism for storing or transmitting information in a form readable by a machine (e.g., a computer). These mechanisms include, but are not limited to, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments.

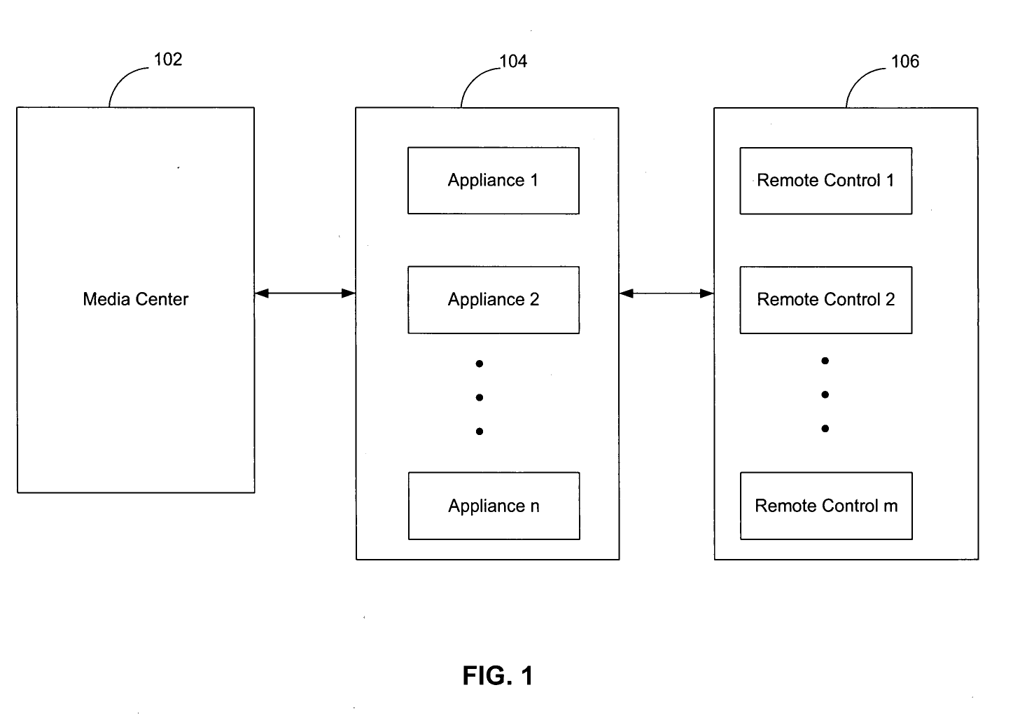

FIG. 1 illustrates one embodiment of an environment for controlling appliances using adaptive UIs, in which some embodiments of the present invention may operate. The specific components shown in FIG. 1 represent one example of a configuration that may be suitable for the invention and is not meant to limit the invention.

Referring to FIG. 1, the environment for controlling appliances using adaptive UIs includes, but is not necessarily limited to, a media center 102, one or more appliances 104 and one or more remote controls 106. Appliances 104 and remote controls 106 are registered with media center 102. In an embodiment not meant to limit the invention, media center 102, appliances 104 and remote controls 106 may be networked together via a 802.11 wireless network. Other networks may be added or substituted for the 802.11 wireless network according to the particular application for the environment in FIG. 1 and as new types of networks are developed.

At a high level, a user (e.g., member of a family) utilizes remote control 106 to click on an icon that turns on appliance 104. Appliance 104 then propagates the command to media center 102. Media center 102 first determines who the user is via authentication and then, based on the authentication, determines which UI to provide the user. Media center 102 then determines which execution environment (EE) (i.e., client piece) to provide to appliance 104. Media center 102 then forwards both the UI and the EE to appliance 104. Appliance 104 then forwards the UI to remote control 106. At this time the user can view and utilize the UI of appliance 104 on remote control 106 to operate appliance 104.

Embodiments of the invention allow each user to use one of remote controls 106 to operate any of the networked appliances 104 in the home. Here, each user has his or her own remote control 106 to operate all of the networked appliances 104 in the home that are registered with media center 102.

In an embodiment of the invention not meant to limit the invention, remote control may 106 be a soft component residing in a personal digital assistant (PDA). Each remote control 106 hosting the soft remote control synchronizes with media center 102 to update an icon database. Appliance registration may be supported by any discovery protocol. In a similar manner, any remote control synchronization protocol may be used. The user can then use remote control 106 to point to the desired networked appliance 104 and click on the appropriate icon to turn on the appliance 104.

Once the user clicks on the appropriate icon to turn on the desired appliance 104, the invention fetches the default UI for the desired appliance 104 and displays it on remote control 106. Embodiments of the invention allow the user to modify the default UI for any of the networked appliances 104 in the home. Here, a simple editor residing in remote control 106 allows the user to modify the default UI. The user modifies the default UI by selecting the options he or she prefers to be displayed with the UI. This modified UI is then saved for the user in media center 102. The next time the saved UI is fetched, only the user's selected options are highlighted on the UI. The options not selected by the user are low-lighted. This provides the user with the option to switch back to the default UI and/or build several variations of his or her modified UI.

Embodiments of the invention allow for differentiated user service levels. The differentiated user service levels may be accomplished by limiting authentication of the user per device and per user. Here, the invention first figures out who the user is based on the authentication process, and then presents the appropriate UI and service level based on the specific appliance and/or the user profile. For example, when dad turns on the television he may be authenticated to view all channels and thus his UI presents to him all available channels for his selection. But, when the child turns on the television it may be the case where he is authenticated to view only a limited number of channels (e.g., Disney, Discovery, etc.) and thus the child's UI only presents the limited number of channels to the child for selection. Thus, the father's service level is differentiated from the child's service level.

Embodiments of the invention allow multiple users to concurrently use their remote controls (or soft controls) 106 to operate different networked appliances 104. For example, a father could use his remote control 106 to operate the thermostat at the same time his son is using his remote control to operate on the television. In an embodiment of the invention, if two different remote controls 106 are used at the same time to operate the same networked appliance 104, then only the first request for use gets through to appliance 104.

Embodiments of the invention allow new versions of manufacturer applications and default UIs to be downloaded on the fly. Here, the user can take advantage of new features of an appliance (e.g., sharing emails or announcements inside the home via a digital television screen) that may be provided by the manufacturer. In an embodiment of the invention, the user uses his or her remote control 106 to first download the new version of the application and default UI onto media center 102 (i.e., server piece). Then the new version of the EE is downloaded onto the networked appliance 104 (i.e., client piece). An icon for the new feature is included in the new UI. Once the EE is downloaded, the new default UI is bound to it. If the EE is associated with the new feature icon on remote control 106, then a device control server of media center 102 automatically figures out whether the new execution environment that is bound to the new UI needs to be downloaded during the UI distribution. Each of media center 102, appliances 104 and remote controls 106 of FIG. 1 is described in more detail next.

The convergence of the television receiver and the personal computer has accelerated with the advent of media center or set-top computer systems. By combining the capabilities of a computer system and a television, media center 102 may provide the user advanced television programming features.

Media center 102 accepts one or more media streams as input. The media streams may have several different possible, including appliances 104, remote controls 106, a television cable, a broadcast antenna, a satellite receiver, a video player, such as a tape or disk player, an audio player, such as a tape, disk or memory player, a digital device connected for example by an IEEE 1394 connection, and so forth. Other inputs may be added or substituted for those described as new inputs are developed and according to the particular application for media center 102. These inputs, after processing, selection and control (by media center 102), may be used to generate different outputs for a user.

The different outputs described above may be received by, but is not necessarily limited to, appliances 104, remote controls 106, a display, a personal video recorder (PVR), compact disk (CD) or digital video disk (DVD) recorder, memory card, and so forth. Other outputs may be added or substituted for those described as new outputs are developed and according to the particular application for media center 102. The audio portion of the output may be routed through an amplifier, such as an A/V receiver or a sound processing engine, to headphones, speakers or any other type of sound generation device.

Media center 102 may also provide connectivity to external devices through, for example, a telephone port, a network port or an infrared port. The UI is provided through, for example, a keyboard or remote controls 106. These examples are not meant to limit the invention.

Media center 102 as described in FIG. 1 is able to support communication through wide area network (WAN) and local area network (LAN) connections, Bluetooth, Institute of Electrical and Electronics Engineers (IEEE) 802.11, universal serial bus (USB), 1394, intelligent drive electronics (IDE), peripheral component interconnect (PCI) and infrared. Other interfaces may be added or substituted for those described as new interfaces are developed and according to the particular application for media center 102.

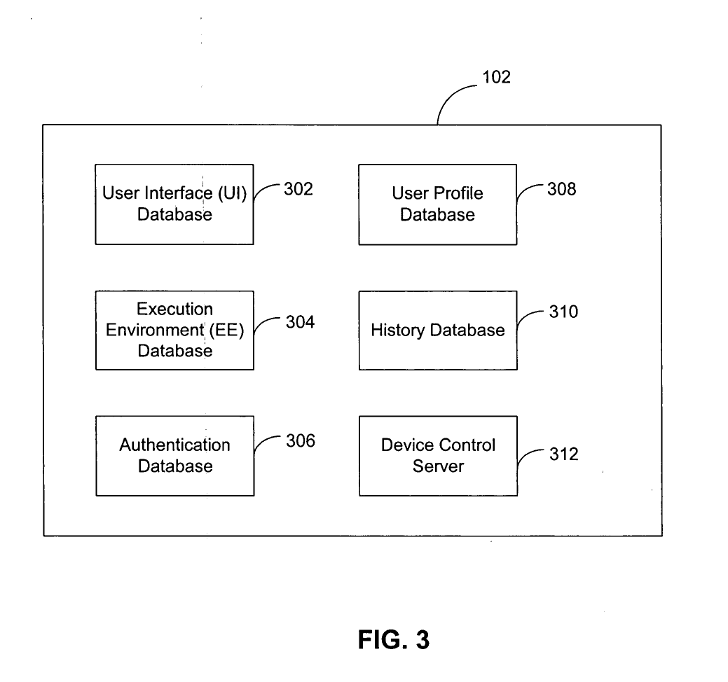

There are many different equipment configurations for media center 102 of FIG. 1 and many different possible choices of equipment to connect. It is to be appreciated that a lesser or more equipped media center 102 than the example described above may be preferred for certain implementations. Therefore, the configuration of media center 102 will vary from implementation to implementation depending upon numerous factors, such as price constraints, performance requirements, technological improvements, or other circumstances. Components of media center 102 utilized by the invention are described below with reference to FIG. 3.

Appliances 104 may include a networked television, a DVD player, a VCR player, an oven, a thermostat, a set-top box, a stereo, a jukebox, or any networked remote control ready device. In an embodiment not meant to limit the invention, remote controls 106 are handheld devices with a full duplex 802.11b radio as an integrated or peripheral attachment. Other types of appliances and/or implementation devices for remote control 106 may be added or substituted for those described as new types of appliances and/or implementation devices for remote control 106 are developed and according to the particular application.

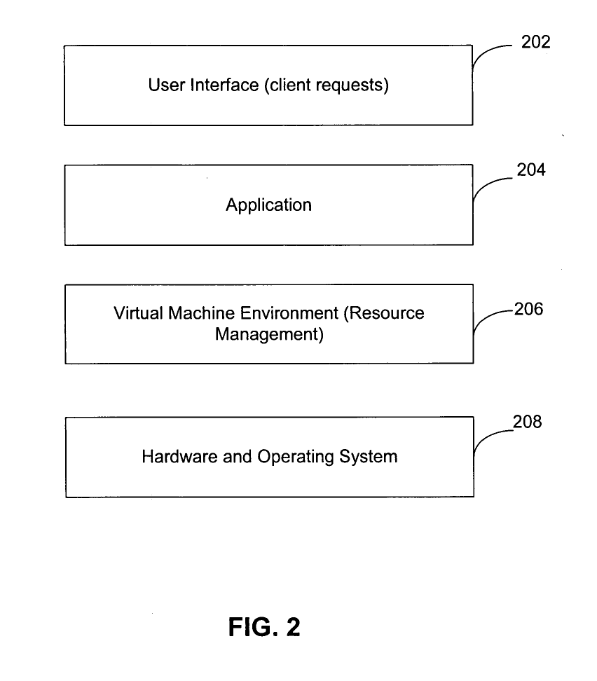

FIG. 2 illustrates a four layer model of networked appliances according to an embodiment of the invention. Referring to FIG. 2, the four layers include a user interface (UI) layer 202, an application layer 204, a virtual machine environment layer 206 and a hardware and operating system layer 208. Each of these layers is briefly described next.

UI layer 202 listens to client requests and brokers the distribution of these client requests to application layer 204. Application layer 204 manages the application state and flow-graph, but is largely unaware of the status of the resources in the network. Virtual machine environment layer 206 handles resource management and component parameterization. Finally, hardware and operating system layer 208 includes the drivers, the node operating system, and so forth. In an embodiment of the invention, UI layer 202 and application layer 204 are separated and then either morphed together or separately morphed.

FIG. 3 illustrates one embodiment of media center 102 in which some embodiments of the present invention may operate. As shown in FIG. 3, media center 102 includes, but is not necessarily limited to, a user interface (UI) database 302, an execution environment (EE) database 304, an authentication database 306, a user profile database 308, a history database 310 and a device control server 312. Each of these components is described next in more detail.

UI database 302 stores the default UI for each networked appliance 104. EE database 304 stores the client piece for each appliance 104. Authentication database 306 stores the necessary information (e.g., login and password) to authenticate the user. User profile database 308 stores each user's modifications to the default UIs and the specifics on the user service levels for each appliance 104. History database 310 saves the command trace for each remote control 106. Maintaining a command trace for each remote control 106 is helpful, for example, for a father to determine what channels his child accessed on a given day. Device control server 312 manages the operation of media center 102.

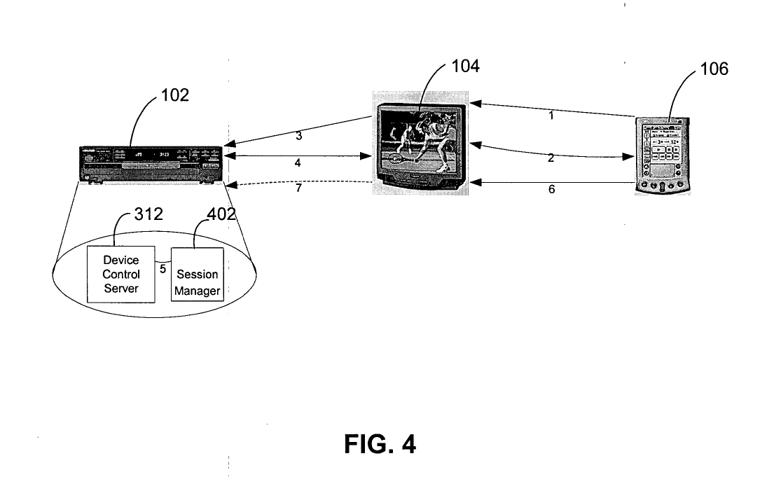

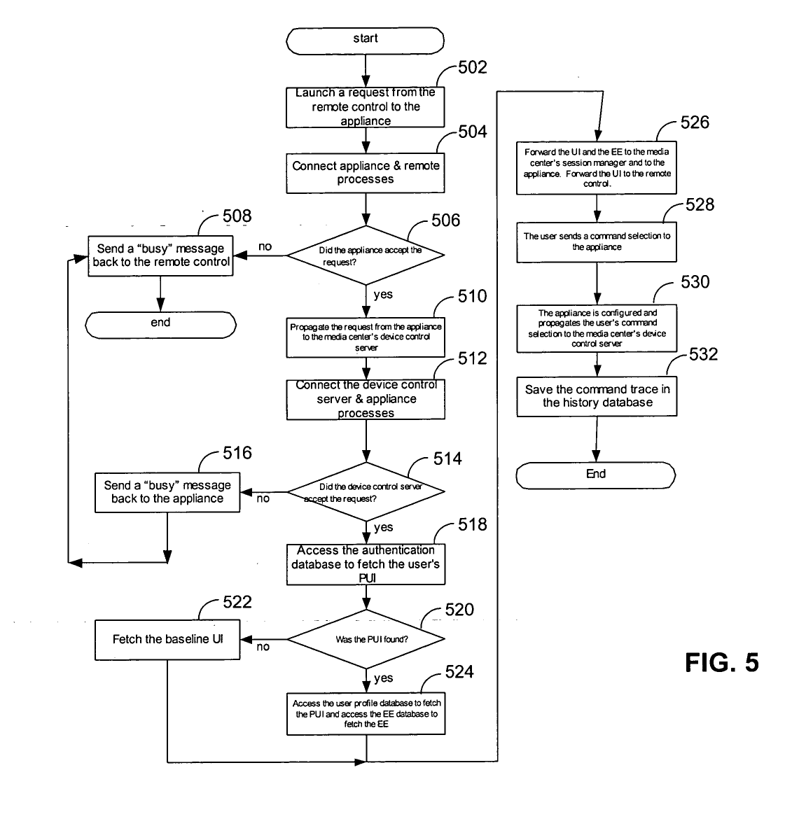

FIG. 4 illustrates one embodiment of session establishment between remote control 106, appliance 104 and media center 102. FIG. 4 further illustrates command selection by the user. Also shown in FIG. 4 are device control server 312 and a session manager 402. The session establishment is illustrated via command flows 1 through 7. The session establishment and command flows 1 through 7 are described in detail in the flowchart of FIG. 5.

FIG. 5 is a flow diagram of one embodiment of a process for establishing a session between remote control 106, appliance 104 and media center 102. Referring to FIG. 5, the process begins at processing block 502 where the user launches a request from remote control 106 to the appliance 104. This step is shown as command flow 1 in FIG. 4.

At processing block 504, the appliance and remote processes are connected. This step is shown as command flow 2 in FIG. 4.

At decision block 506, it is determined whether appliance 104 accepted the request. If not, then processing continues at processing block 508 where a busy message is sent back to remote control 106. The process of FIG. 5 ends at this point. Alternatively, if at decision block 506 it is determined that appliance 104 accepted the request, then processing continues at processing block 510.

At processing block 510, the request is propagated from appliance 104 to device control server 312 in media center 102. This step is shown as command flow 3 in FIG. 4. At processing block 512, the device control server process and the appliance process are connected. This step is shown as command flow 4 in FIG. 4.

At decision block 514, it is determined whether device control server 312 accepted the request. If not, then processing continues at processing block 516 where a busy message is sent back to appliance 104. Control then flows to processing block 508 where a busy message is sent back to remote control 106. The process of FIG. 5 ends at this point. Alternatively, if at decision block 514 it is determined that device control server 312 accepted the request, then processing continues at processing block 518. Decision block 514 is shown as command flow 5a in FIG. 4.

At processing block 518, authentication database 306 is accessed to fetch the user's portable user interface (PUI), if applicable. Here, based on the authentication of the user via authentication database 306, it is determined whether the user has a modified UI and/or a set user service level. This may be determined via an index stored in authentication database 306. As described above, embodiments of the invention allow for differentiated user service levels. The differentiated user service levels may be accomplished by limiting authentication of the user per device and per user. Here, the invention first figures out who the user is based on the authentication process, and then presents the appropriate UI and service level based on the specific appliance and/or the user profile. This step is shown as command flow 5b in FIG. 4.

At decision block 520, it is determined whether the PUI was found in authentication database 306 (i.e., whether an index was found for the user and thus the user has a modified UI and/or service level). If not, then processing continues at processing block 522 where the baseline or default UI is fetched from UI database 302. Alternatively, if at decision block 520 the PUI was found in authentication database 306, then processing continues at processing block 524.

At processing block 524, user profile database 308 is accessed to fetch the PUI and EE database 304 is accessed to fetch the EE. This step is shown as command flow 5c in FIG. 4.

At processing block 526, the UI and the EE are forwarded to session manager 402 and to appliance 104. In addition, the UI is forwarded to remote control 106. This step is shown as command flows 5d-5f in FIG. 4.

At processing block 528, the user uses the UI (now displayed on remote control 106) to send a command selection to appliance 104. This step is shown as command flow 6a in FIG. 4.

At processing block 530, appliance 104 is configured and propagates the user's command selection to device control server 312. This step is shown as command flows 6b and 6c in FIG. 4.

At processing block 532, the command trace is saved in history database 310. The process of FIG. 5 ends at this point.

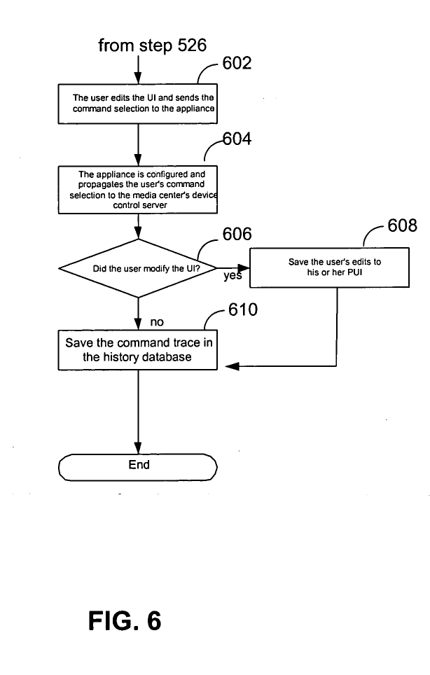

FIG. 6 is a flow diagram of one embodiment of a process for allowing the user to modify a default UI. As described above, embodiments of the invention allow the user to modify the default UI for any of the networked appliances 104 in the home. Here, a simple editor residing in remote control 106 allows the user to modify the default UI. Referring to FIG. 6, the process flows from step 526 of FIG. 5 to processing block 602.

At processing block 602, the user uses an editor residing in remote control 106 to edit the default UI (or a previously modified UI) and sends the command selection to appliance 104 to record the modifications. At processing block 604, appliance 104 is configured and propagates the user's command selection to device control server 312.

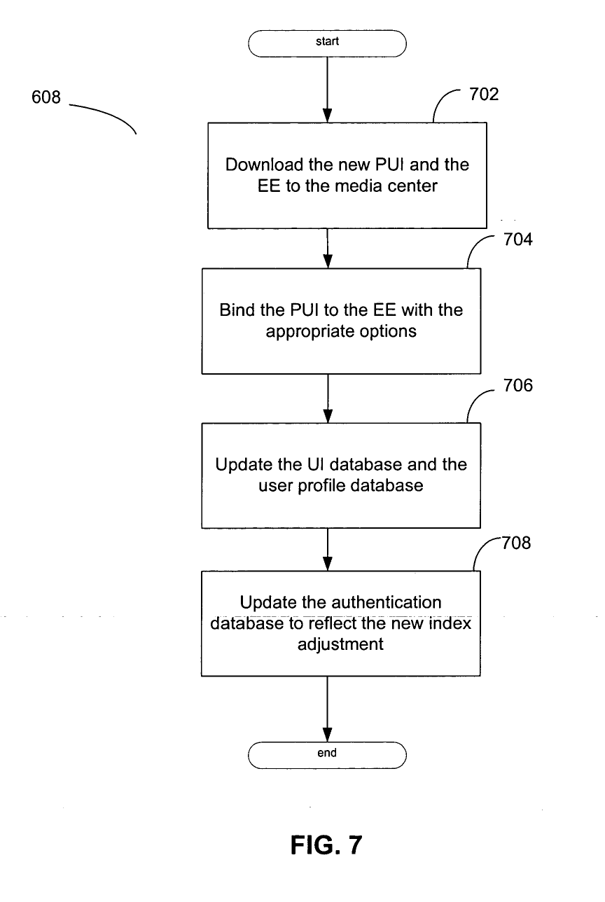

At decision block 606, it is determined whether the user modified the default UI. If so, then processing continues at processing block 608 where the user's edits to his or her PUI are saved in user profile database 308. Processing block 608 is described in more detail with reference to FIG. 7 below. If it is determined at decision block 606 that the user did not modify the default UI, then processing continues at processing block 610. At processing block 610, the command trace is saved in history database 310. The process of FIG. 6 ends at this point.

FIG. 7 a flow diagram of one embodiment of a process for saving the user's edits to his or her PUI (processing block 608 of FIG. 6). Referring to FIG. 7, the process begins at processing block 702 where the new PUI and the EE are downloaded to media center 102.

At processing block 704, the PUI is bound to the EE with the appropriate options. As described above, the user modifies the default UI by selecting the options he or she prefers to be displayed with the UI. This modified UI is then saved for the user in media center 102. The next time the saved UI is fetched, only the user's selected options are highlighted on the UI. The options not selected by the user are low-lighted. This provides the user with the option to switch back to the default UI and/or build several variations of his or her modified UI.

At processing block 706, UI database 302 and user profile database 308 are updated. At processing block 708, authentication database 306 is updated to reflect the new index adjustment for the user. The process in FIG. 7 ends at this point.

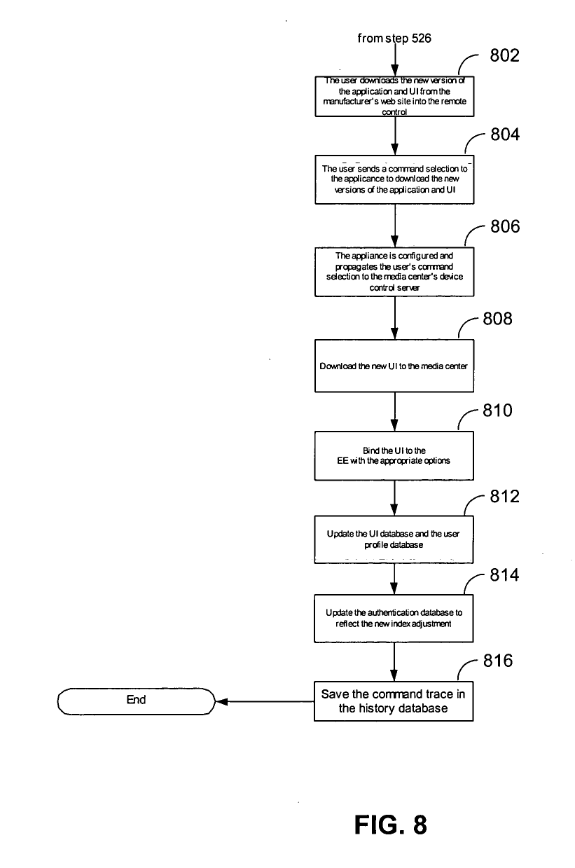

FIG. 8 is a flow diagram of one embodiment of a process for downloading new versions of manufacturer appliance applications and default UIs. As described above, embodiments of the invention allow new versions of manufacturer applications and default UIs to be downloaded on the fly. Here, the user can take advantage of new features of an appliance (e.g., sharing emails or announcements inside the home via a digital television screen) that may be provided by the manufacturer. Referring to FIG. 8, the process flows from step 526 of FIG. 5 to processing block 802.

At processing block 802, the user downloads the new version of the application and default UI from the manufacturer's web site into remote control 106. The new versions of the application and default UI may also be downloaded from a CD, disk, or any other medium capable of storing the new versions of the application and default UI.

At processing block 804, the user sends a command selection to appliance 104 to download the new versions of the application and UI. At processing block 806, appliance 104 is configured and then propagates the user's command selection to device control server 312 in media center 102.

At processing block 808, the new UI is downloaded to media center 102. At processing block 810, the new UI is bound to the EE with the appropriate options. Here, the options are the default options unless the user modified the new UI. At processing block 812, UI database 302 and user profile database 308 are updated to reflect the new UI.

At processing block 814, authentication database 306 is updated to reflect the new index adjustment for the new UI. At processing block 816, the command trace is saved in history database 310. The process in FIG. 8 ends at this point.

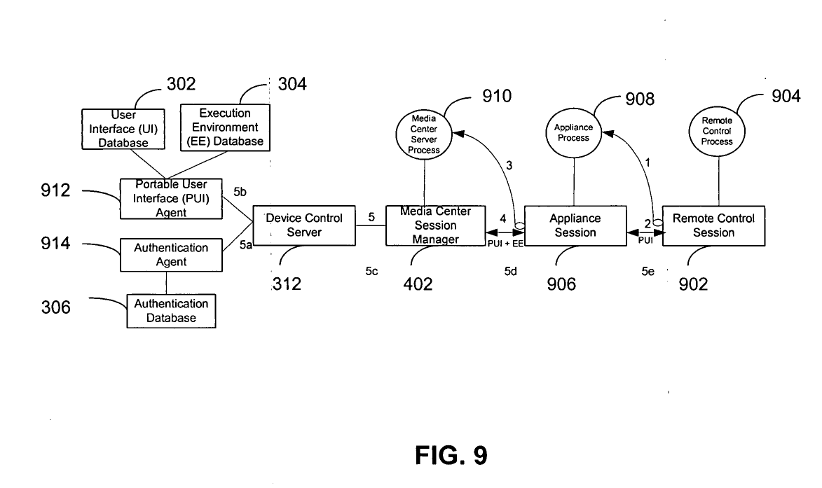

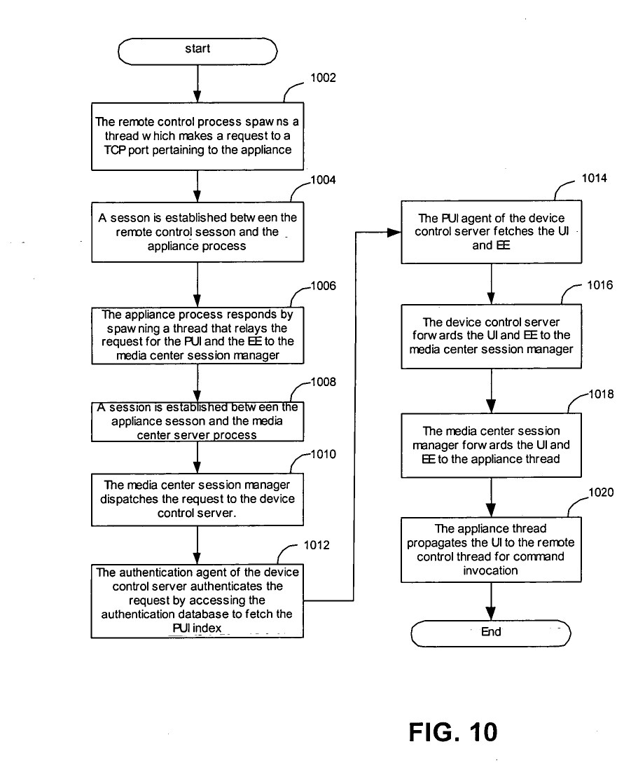

FIG. 9 illustrates one embodiment of a software implementation for establishing a session between remote control 106, appliance 104 and media center 102. The flow diagram in FIG. 9 includes, but is not necessarily limited to, a remote control session 902, a remote control process 904, an appliance session 906, an appliance process 908, a media center session manager 402, a media center server process 910, device control server 312, UI database 302, EE database 304, a portable user interface (PUI) agent 912, an authentication agent 914 and authentication database 306. The session establishment is illustrated in via command flows 1 through 5e. The session establishment and command flows 1 through 5e are described in detail in the flowchart of FIG. 10.

FIG. 10 is a flow diagram of one embodiment of a software implementation for establishing a session between remote control 106 (via remote control session 902 and remote control process 904), appliance 104 (via appliance session 906 and appliance process 908) and media center 102 (via media center session manager 402 and media center server process 910). Referring to FIG. 10, the process begins at processing block 1002 where remote control process 904 spawns a thread which makes a request to a TCP port pertaining to appliance 104. This step is shown as command flow 1 in FIG. 9.

At processing block 1004, a session is established between remote control session 902 and appliance process 908. This step is shown as command flow 2 in FIG. 9.

At processing block 1006, appliance process 908 responds by spawning a thread that relays the request for the PUI and the EE to media center session manager 402. This step is shown as command flow 3 in FIG. 9.

At processing block 1008, a session is established between appliance session 906 and media center server process 910. This step is shown as command flow 4 in FIG. 9.

At processing block 1010, media center session manager 402 dispatches the request to device control server 312. This step is shown as command flow 5 in FIG. 9.

At processing block 1012, authentication agent 914 authenticates the request by accessing authentication database 306 to fetch the PUI index. This step is shown as command flow 5a in FIG. 9.

At processing block 1014, PUI agent 912 fetches the UI from UI database 302 and the EE from EE database 304. This step is shown as command flow 5b in FIG. 9.

At processing block 1016, device control server 312 forwards the UI and the EE to media center session manager 402. This step is shown as command flow 5c in FIG. 9.

At processing block 1018, media center session manager 402 forwards the UI and the EE to the appliance thread. This step is shown as command flow 5d in FIG. 9.

At processing block 1020, the appliance thread propagates the UI to the remote control thread for command invocation by the user. This step is shown as command flow 5e in FIG. 9. The flowchart in FIG. 10 ends at this point.

A method and system for controlling appliances using adaptive UIs have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
establishing a session between a remote control, a device and a media center;
authenticating a user at the media center to determine a user interface and an execution environment for the device;
sending the user interface and the execution environment to the device;
sending the user interface to the remote control; and
receiving a command at the media center from the user via the remote control and the user interface to operate the device.

2. The method of claim 1, wherein the remote control, the device and the media center are connected via a wireless network.

3. The method of claim 1, wherein the remote control is a handheld device with integrated full duplex 802.11b compatability.

4. The method of claim 1, wherein the remote control is a handheld device with a peripheral attachment having full duplex 802.11b compatability.

5. The method of claim 1, wherein the command comprises downloading modifications to the user interface.

6. The method of claim 5, wherein the modifications to the user interface are done by the user via the remote control.

7. The method of claim 1, wherein the command comprises downloading a new application and a new user interface for the device.

8. The method of claim 7, wherein the new application and the new user interface are downloaded by the user from a manufacturer's web site via the remote control.

9. The method of claim 1, further comprising saving a trace for the command at the media center.

10. A system comprising a media center that establishes a session between the media center, a device and a remote control, wherein the media center authenticates a user to determine a user interface and an execution environment for the device, wherein the media center sends the user interface and the execution environment to the device, wherein the media center sends the user interface to the remote control, and wherein the media center receives a command from the user via the remote control and the user interface to operate the device.

11. The system of claim 10, wherein the remote control, the device and the media center are connected via a wireless network.

12. The system of claim 10, wherein the remote control is a handheld device with integrated full duplex 802.11b compatability.

13. The system of claim 10, wherein the remote control is a handheld device with a peripheral attachment having full duplex 802.11b compatability.

14. The system of claim 10, wherein the command comprises downloading modifications to the user interface.

15. The system of claim 14, wherein the modifications to the user interface are done by the user via the remote control.

16. The system of claim 10, wherein the command comprises downloading a new application and a new user interface for the device.

17. The system of claim 16, wherein the new application and the new user interface are downloaded by the user from a manufacturer's web site via the remote control.

18. The system of claim 10, wherein the media center saves a trace for the command.

19. A machine-readable medium containing instructions which, when executed by a processing system, cause the processing system to perform a method, the method comprising:
establishing a session between a remote control, a device and a media center;
authenticating a user at the media center to determine a user interface and an execution environment for the device;
sending the user interface and the execution environment to the device;
sending the user interface to the remote control; and
receiving a command at the media center from the user via the remote control and the user interface to operate the device.

20. The machine-readable medium of claim 19, wherein the remote control, the device and the media center are connected via a wireless network.

21. The machine-readable medium of claim 19, wherein the remote control is a handheld device with integrated full duplex 802.11b compatability.

22. The machine-readable medium of claim 19, wherein the remote control is a handheld device with a peripheral attachment having full duplex 802.11b compatability.

23. The machine-readable medium of claim 19, wherein the command comprises downloading modifications to the user interface.

24. The machine-readable medium of claim 23, wherein the modifications to the user interface are done by the user via the remote control.

25. The machine-readable medium of claim 19, wherein the command comprises downloading a new application and a new user interface for the device.

26. The machine-readable medium of claim 25, wherein the new application and the new user interface are downloaded by the user from a manufacturer's web site via the remote control.

27. The machine-readable medium of claim 19, further comprising saving a trace for the command at the media center.
